(19) United States
(12) Patent Application Publication
(10) Pub. No.: US 2004/0168933 A1
(43) Pub. Date: Sep. 2, 2004

(54) Method and apparatus for producing electrolyzed water

(76) Inventor: Takao Inoue, Hujisawa-shi (JP)

Correspondence Address: JORDAN AND HAMBURG LLP, 122 EAST 42ND STREET, SUITE 4000, NEW YORK, NY, 10168, US

(21) Appl. No.: 10/375,969

(22) Filed: Feb. 28, 2003

(51) Int. Cl. C02F 1/461; C25D 17/00

(52) U.S. Cl. 205/746; 204/263

(57) ABSTRACT

The present invention provides a method and an apparatus for producing electrolyzed water, in which an anion-exchange membrane 2 is provided in an electrolytic cell 1 so as to separate the electrolytic cell 1 to two chambers at the center; each of the chambers separated by the anion-exchange membrane 2 has a discharge port 11a or 11b for the electrolyzed water; an electrode is disposed in each of the chambers of the electrolytic cell 1; a power source is electrically connected to each of the electrodes so as to apply voltage between each of the electrodes; and an electrode selector 5 switches the polarity of each of the electrodes at predetermined time intervals. Thus, it is possible to continuously supply the acidic water maintaining the required concentration of chlorine, improve the efficiency of the treatment and decrease the manpower for cleaning the anion-exchange membrane.

### BACKGROUND OF THE INVENTION

1. Field of the Invention

The present invention relates to a method and an apparatus for producing electrolyzed water, particularly to a method and an apparatus for producing the electrolyzed water suitable for producing disinfecting electrolyzed acidic water.

2. Description of the Prior Art

When a conventional method and apparatus for producing electrolyzed water is used, this involves: introducing a solution of salt into an electrolytic cell which is separated to two chambers by an anion-exchange membrane and has an electrode in each of the chambers; and applying voltage between each of the electrodes to produce acidic water in a chamber having a positive (+) electrode and alkaline ion water in a chamber having a negative (−) electrode. The produced acidic water, when used a sad is infectant has a chlorine concentration of from 30 to 200 ppm, preferably from 30 to 100 ppm, and desirably has a pH of 2.5±0.2.

Although tap water is usually utilized for the solvent of an aqueous electrolyte solution, the tap water contains impurities such as calcium ions. In a conventional method and apparatus for producing electrolyzed water, the calcium ions in the aqueous electrolyte solution in the chamber having a negative (−) electrode are gradually deposited on an anion-exchange membrane as calcium compounds and interfere with the permeation of chlorine ions through the anion-exchange membrane. In the chamber having a positive (+) electrode, the chlorine ions in the aqueous electrolyte solution decrease by producing chlorine gas while no chlorine ions permeate from a negative (−) electrode side chamber. Consequently, the chlorine concentration decreases in a positive (+) electrode side chamber, resulting in a problem that the chlorine concentration required for disinfecting water cannot be maintained.

In order to cope with this problem, in prior arts, it is necessary to clean the anion-exchange membrane at predetermined time intervals to remove the calcium compounds. Since the electrolysis treatment has to be interrupted during the cleaning, there have been such problems that (1) acidic water cannot be supplied continuously; (2) efficiency of the treatment is low; and (3) the cleaning of the anion-exchange membrane requires manpower.

### BRIEF SUMMARY OF THE INVENTION

The present invention has been created focusing attention on these problems. It is an object of the present invention to provide a method and an apparatus for producing electrolyzed water capable of continuously supplying the acidic water maintaining the required concentration of chlorine, improving the efficiency of treatment and reducing the manpower for cleaning the anion-exchange membrane.

To achieve the above described object, the method for producing electrolyzed water according to the present invention comprises a method for producing electrolyzed water comprising: introducing aqueous electrolyte solution containing chlorine ions into an electrolytic cell which is separated to two chambers by an anion-exchange membrane and has an electrode in each of the chambers; and applying voltage between each of the electrodes to form acidic water in a chamber having a positive (+) electrode and alkaline ion water in a chamber having a negative (−) electrode, wherein the polarity of each of the electrodes is switched at time intervals that the aqueous electrolyte solution in each of the chambers is switched between the acidic water and the alkaline ion water. The electrolytic solution is preferably a solution of salt. The anion-exchange membrane may have a polymeric compound attached on the membrane surface which allows only monovalent ions to selectively permeate and prevents the membrane from degradation due to the deposition of calcium compound and the like.

In the method for producing electrolyzed water according to the present invention, the aqueous electrolyte solution in each of the chambers is switched between acidic water and alkaline ion water by switching the polarity of each of the electrodes. Therefore, even if calcium compounds deposit on an anion-exchange membrane in a chamber having a negative (−) electrode, the calcium compounds deposited on the anion-exchange membrane will be dissolved in the acidic water when the electrode in the chamber is switched to a positive (+) electrode and the electrolytic solution inside the chamber is switched to the acidic water. Thus, it is possible to remove the calcium compounds from the anion-exchange membrane and maintain it so as to allow chloride ions to permeate.

Since chlorine ions can permeate an anion-exchange membrane, the chlorine ions in a negative (−) electrode chamber can move to a positive (+) electrode chamber and can suppress reduction of the chlorine concentration ions in the positive (+) electrode chamber, whereby the chlorine concentration ions required for the disinfecting water can be maintained. Furthermore, since it is not necessary to interrupt the electrolysis treatment by cleaning the anion-exchange membrane, it is possible to continuously supply acidic water and improve the efficiency of the treatment.

In the method for producing electrolyzed water according to the present invention, an acidic water supply port and an alkaline ion water supply port are provided and each of the chambers has a drain outlet for discharging an aqueous electrolyte solution, wherein the drain outlet of each of the chambers is preferably connected to the above described acidic water supply port when the disposed electrode is a positive (+) electrode and to the above described alkaline ion water supply port when the disposed electrode is a negative (−) electrode. In this case, it is possible to always supply acidic water from the acidic water supply port and alkaline ion water from the alkaline ion water supply port.

Further, in the method for producing electrolyzed water according to the present invention, an acidic water tank is connected to the above described acidic water supply port, and the polarity of each of the electrodes is preferably switched at time intervals that the acidic water in the above described acidic water tank is maintained at pH of 2.5±0.2. In this case, it is possible to store the acidic water having the pH always suitable for disinfecting water in the acidic water tank.

Further, in the method for producing electrolyzed water according to the present invention, it is preferable to continuously feed the above described aqueous electrolyte solution into the above described electrolytic cell so as to maintain the chlorine concentration of the aqueous electrolyte solution in the above described electrolytic cell in the range from 30 to 200 ppm. In this case, it is possible to obtain the acidic water having the chlorine concentration always suitable for disinfecting water. The chlorine concentration of the aqueous electrolyte solution in the electrolytic cell is preferably maintained particularly in the range from 30 to 100 ppm.

The apparatus for producing electrolyzed water according to the present invention comprises an electrolytic cell, an anion-exchange membrane provided in the above described electrolytic cell so as to separate the electrolytic cell to two chambers, electrodes placed in each of the chambers of the above described electrolytic cell, a power source for applying voltage between each of the electrodes, and an electrode selector for switching the polarity of each of the electrodes at predetermined time intervals.

In the apparatus for producing electrolyzed water according to the present invention, an aqueous electrolyte solution containing chlorine ions is put in an electrolytic cell; voltage is applied between each of the electrodes by a power source; acidic water is formed in the chamber having a positive (+) electrode; and alkaline ion water is formed in the chamber having a negative (−) electrode. By means of an electrode selector, the polarity of each of the electrodes is switched at time intervals that the aqueous electrolyte solution in each of the chambers is switched between the acidic water and the alkaline ion water. Thus, the above described method for producing electrolyzed water can be implemented to obtain the action and the effect thereof.

Preferably, the apparatus for producing electrolyzed water according to the present invention comprises a water feeding port of an aqueous electrolyte solution into the above described electrolytic cell, a supply port of acidic water and a supply port of alkaline ion water, and each of the chambers comprises a drain outlet and a connection selector for connecting the drain outlet of each of the chambers to the above described acidic water supply port when the disposed electrode is a positive (+) electrode and to the above described alkaline ion water supply port when the disposed electrode is a negative (−) electrode. In this case, it is possible to always supply acidic water from the acidic water supply port and alkaline ion water from the alkaline ion water supply port by connecting the drain outlet of each of the chambers to the acidic water supply port or to the alkaline ion water supply port with the connection selector.

Furthermore, preferably, in the apparatus for producing electrolyzed water according to the present invention, the above described connection selector comprises an electromagnetic valve, and the polarity of the above described electromagnetic valve is switched by the above described electrode selector to connect the drain outlet of each of the chambers to the above described acidic water supply port when the disposed electrode is a positive (+) electrode and to the above described alkaline ion water supply port when the disposed electrode is a negative (−) electrode. In this case, it is possible to easily match the timing for connecting the drain outlet of the chamber producing acidic water to an acidic water supply port and the drain outlet of the chamber producing alkaline ion water to an alkaline ion water supply port.

### BRIEF DESCRIPTION OF THE DRAWINGS

FIG. 1(A) is a schematic view for illustrating the electrical wiring and the flow paths of acidic water and alkaline ion water in the apparatus for producing electrolyzed water according to the embodiments of the present invention when the power source of the electrode selector is ON;

FIG. 1(B) is a schematic view for illustrating the electrical wiring and the flow paths of acidic water and alkaline ion water in the apparatus for producing electrolyzed water according to the embodiments of the present invention when the power source of the electrode selector is OFF;

FIG. 2 is an illustrative picture showing the state of the aqueous electrolyte solution in the electrolytic cell in the apparatus for producing the electrolyzed water shown in FIG. 1;

FIG. 3 is an illustrative picture showing the state in which the polarity of the electrodes is switched from the state shown in FIG. 2 in the apparatus for producing the electrolyzed water shown in FIG. 1;

FIG. 4 is a graphical representation showing the transition of the chlorine concentration of the acidic water produced in a conventional apparatus for producing the electrolyzed water;

FIG. 5 is a graphical representation showing the transition of the chlorine concentration of the acidic water produced in the apparatus for producing the electrolyzed water according to the embodiments of the present invention;

FIG. 6(A) is a schematic perspective view showing an overflow-type endoscope cleaning-disinfecting device utilizing the acidic water produced in the apparatus for producing the electrolyzed water according to the embodiments of the present invention; and

FIG. 6(B) is a schematic longitudinal section showing an overflow-type endoscope cleaning-disinfecting device utilizing the acidic water produced in the apparatus for producing the electrolyzed water according to the embodiments of the present invention.

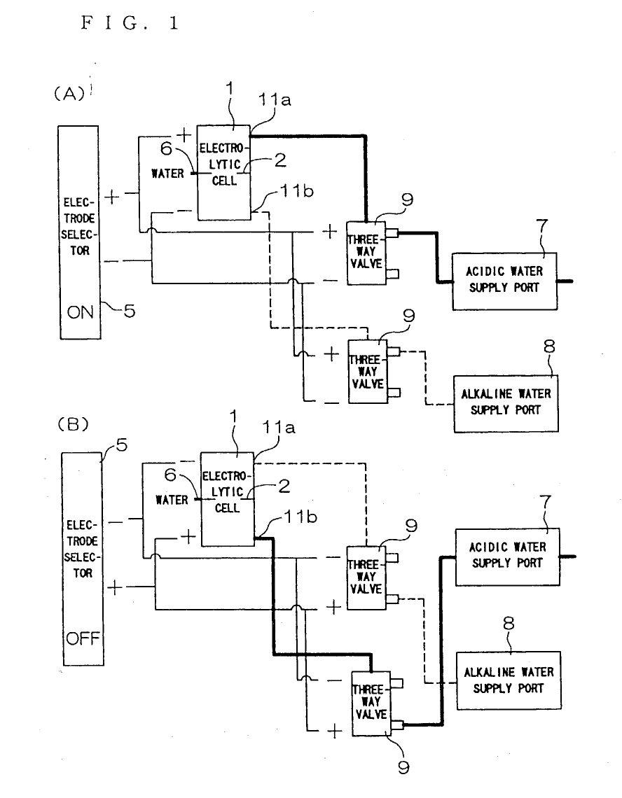

FIG. 1(A)

5 ELECTRODE SELECTOR

1 ELECTROLYTIC CELL

9 THREE-WAY VALVE

7 ACIDIC WATER SUPPLY PORT

8 ALKALINE WATER SUPPLY PORT

#1 WATER

FIG. 1(B)

5 ELECTRODE SELECTOR

1 ELECTROLYTIC CELL

9 THREE-WAY VALVE

7 ACIDIC WATER SUPPLY PORT

8 ALKALINE WATER SUPPLY PORT

#1 WATER

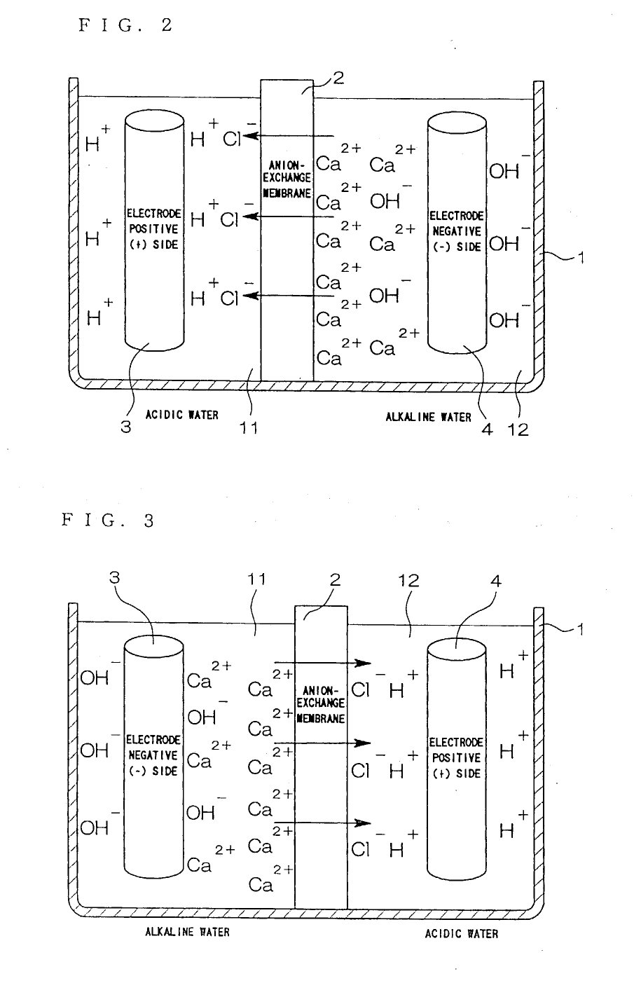

FIG. 2

3 ELECTRODE POSITIVE (+) SIDE

4 ELECTRODE NEGATIVE (−) SIDE

2 ANION-EXCHANGE MEMBRANE

#1 ACIDIC WATER

#2 ALKALINE WATER

FIG. 3

4 ELECTRODE POSITIVE (+) SIDE

3 ELECTRODE NEGATIVE (−) SIDE

2 ANION-EXCHANGE MEMBRANE

#1 ACIDIC WATER

#2 ALKALINE WATER

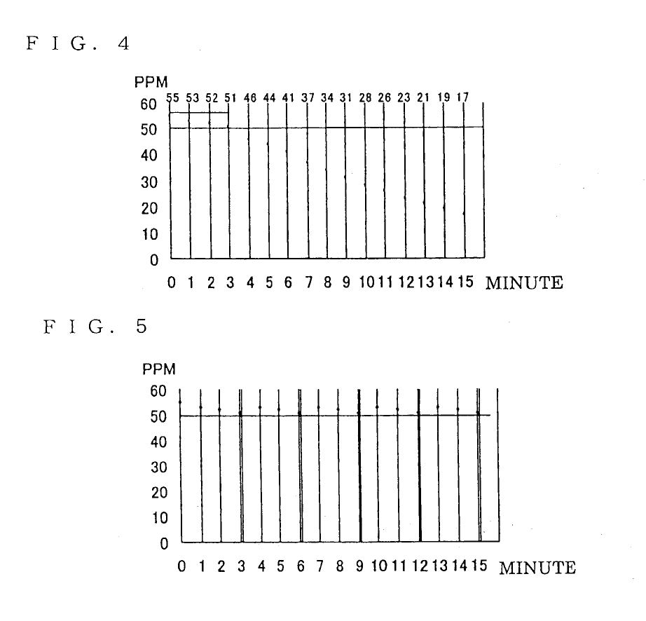

FIG. 4

#1 MINUTE

FIG. 5

#1 MINUTE

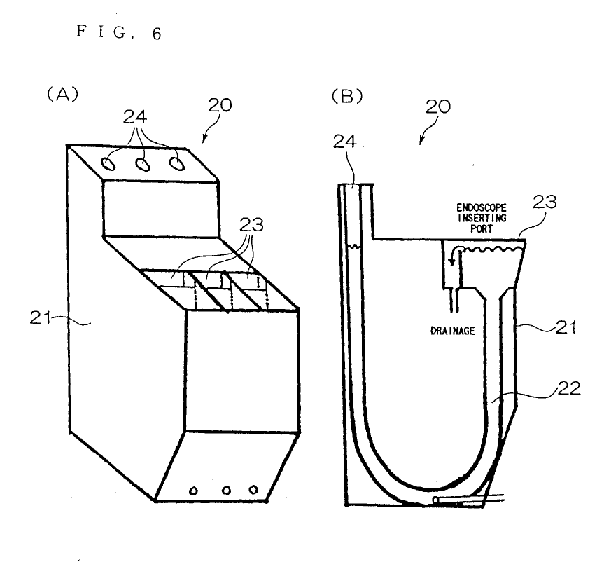

FIG. 6(B)

#1 ENDOSCOPE INSERTING PORT

#2 DRAINAGE

### DETAILED DESCRIPTION OF THE PREFERRED EMBODIMENTS

The embodiments of the present invention will now be described with reference to the drawings.

As shown in FIGS. 1, 2 and 3, the apparatus for producing electrolyzed water comprises an electrolytic cell 1, an anion-exchange membrane 2, electrodes 3 and 4, a power source (not shown), an electrode selector 5, a water feeding port 6, an acidic water supply port 7, an alkaline ion water supply port 8 and a connection selector 9.

As shown in FIGS. 2 and 3, the anion-exchange membrane 2 is provided in the electrolytic cell 1 so as to separate the electrolytic cell 1 to two chambers 11, 12 at the center. Each of the chambers 11, 12 separated by the anion-exchange membrane 2 has a drain outlet 11a or 11b of the electrolyzed water. The electrodes 3, 4 are disposed in each of the chambers 11, 12 of the electrolytic cell 1. The power source is electrically connected to each of the electrodes 3, 4 so as to apply voltage between each of the electrodes 3, 4. The power source of 100V for home use may be used for the power source. The electrode selector 5 has a timer so that the polarity of each of the electrodes 3, 4 is switched in predetermined time intervals. The time intervals for switching may be set arbitrarily.

The water feeding port 6 is provided so as to feed an aqueous electrolyte solution into the electrolytic cell 1. The aqueous electrode solution is continuously fed into the electrolytic cell 1 so that the chlorine concentration in the aqueous electrolyte solution therein is maintained in the range from 30 to 200 ppm, preferably from 30 to 100 ppm, more preferably approximately 50 ppm. Hereby, it is possible to obtain the acidic water having the chlorine concentration always suitable for disinfecting water.

The connection selector 9 has a three-way valve comprising an electromagnetic valve. The polarity of the three-way valve is switched by the electrode selector 5 to connect the drain outlet 11a or 11b of each of the chambers 11, 12 to the acidic water supply port 7 when the disposed electrode 3 or 4 is a positive (+) electrode and to the above described alkaline ion water supply port 8 when the disposed electrode 3 or 4 is a negative (−) electrode. It is possible to always supply acidic water from the acidic water supply port 7 and alkaline ion water from the alkaline ion water supply port 8 by connecting the drain outlet 11a or 11b of each of the chambers 11, 12 to the acidic water supply port 7 or to the alkaline ion water supply port 8 with the connection selector 9. In addition, it is possible to easily match the timing for connecting the drain outlet 11a or 11b of the chamber 11 or 12 producing acidic water to the acidic water supply port 7 and the drain outlet 11a or 11b of the chamber 11 or 12 producing alkaline ion water to the alkaline ion water supply port 8.

In use, in the apparatus for producing the electrolyzed water, a solution of salt is introduced as an aqueous electrolyte solution into the electrolytic cell 1, and voltage is applied between each of the electrodes 3, 4 by the power source. As shown in FIG. 2, in the chamber 11 having the positive (+) electrode 3, the hydrogen ion concentration increases due to the ionization of water to produce acidic water. In the chamber 12 having the negative (−) electrode 4, the hydroxide ion concentration increases to produce alkaline ion water. The salt concentration in a solution of salt is preferably about 20% by weight. Tap water may be used for the water for a solution of salt. Tap water usually contains impurities such as calcium ions. The feeding rate of a solution of salt into the electrolytic cell 1 is preferably one liter per minute.

If the polarity of the electrodes 3, 4 in each of the chambers 11, 12 is maintained, with reference to FIG. 2, in the chamber 12 having the negative (−) electrode, calcium ions in the aqueous electrode solution gradually are deposited on the anion-exchange membrane 2 as calcium compounds, preventing chlorine ions from permeating the anion-exchange membrane 2. In the chamber 11 having the positive (+) electrode 3, chlorine ions in the aqueous electrolyte solution decrease by producing chlorine gas while no chlorine ions are permeated from the negative (−) electrode chamber 12. Consequently, the chlorine concentration decreases in the positive (+) electrode chamber 11, resulting in the fact that the chlorine concentration required for disinfecting water cannot be maintained.

In order to prevent the problem, in the apparatus for producing electrolyzed water, the polarity of each of the electrodes 3, 4 is switched as shown in FIG. 3 by the electrode selector 5. The time interval for switching the polarity between each of the electrodes 3, 4 is set at the time interval that the aqueous electrolyte solution in each of the chambers 11, 12 is switched between acidic water and alkaline ion water. The time interval for switching the polarity of each of the electrodes 3, 4 is, for example, every three minutes. By switching the polarity of each of the electrodes 3, 4, the aqueous electrolyte solution in each of the chambers 11, 12 is switched between acidic water and alkaline ion water. Consequently, even if calcium compounds are deposited on the anion-exchange membrane 2 in the chamber 12 having the negative (−) electrode 4 in FIG. 2, the calcium compounds deposited on the anion-exchange membrane 2 are dissolved in the acidic water when the aqueous electrolyte solution is switched to the acidic water by switching the electrode 4 in the chamber 12 to the positive (+) electrode as shown in FIG. 3. Thus, it is possible to remove the calcium compounds from the anion-exchange membrane 2 and maintain it to allow permeation of chlorine ions. In the case magnesium compounds are deposited on the anion-exchange membrane 2 by magnesium ions contained in tap water, the magnesium compounds can also be removed similarly from the anion-exchange membrane 2.

Since chlorine ions can permeate the anion-exchange membrane 2, the chlorine ions in the negative (−) chamber 11 or 12 can move to the positive (+) chamber 11 or 12, thereby suppressing the reduction of the chlorine concentration. In the case of the conventional apparatus for producing electrolyzed water in which the polarity of the electrodes 3 or 4 in each of the chambers 11 or 12 is kept unchanged, the chlorine concentration of the acidic water produced gradually decreases from an initial concentration of 55 ppm to 17 ppm in 15 minutes, for example, as shown in FIG. 4. On the other hand, in the case of the apparatus for producing electrolyzed water according to the present embodiments, the concentration above 50 ppm can always be maintained, as shown in FIG. 5 as an example. By the way, part of the chlorine ions in the acidic water changes to hypochlorous acid ions. The concentration of hypochlorous acid in the acidic water is preferably maintained approximately 50 ppm for sterilization.

Thus, the apparatus for producing electrolyzed water can maintain the chlorine concentration required for disinfecting water while decreasing the manpower for cleaning the anion-exchange membrane 2. In addition, since it is not necessary to interrupt the electrolysis treatment by the cleaning of the anion-exchange membrane 2, it is possible to continuously supply the acidic water maintaining the required concentration of chlorine, thereby improving the efficiency of the treatment.

The apparatus for producing electrolyzed water is suitable for use in an overflow-type endoscope cleaning-disinfecting device 20 shown in FIG. 6. The overflow-type endoscope cleaning-disinfecting device 20 has an acidic water tank 22 with a U-shaped cross section suitable for inserting an endoscope in an exterior casing 21. An endoscope inserting port 23 is provided at one end of the acidic water tank 22, and a supply port connection part 24 is provided at the other end. The endoscope inserting port 23 is adapted to discharge excessive water by overflowing. The supply port connection part 24 can be connected to the acidic water supply port 7 of the apparatus for producing electrolyzed water.

When the apparatus for producing electrolyzed water is used together with the overflow-type endoscope cleaning-disinfecting device 20, the polarity of each of the electrodes 3, 4 is switched by the electrode selector 5 at time intervals that the acidic water in the acidic water tank is maintained at a pH of 2.5±0.2. Hereby, it is possible to store the acidic water always having the pH suitable for the disinfecting water in the acidic water tank. Note that the alkaline ion water produced in the apparatus for producing electrolyzed water is suitable for cleaning and removing blood or saliva adhered to the endoscope.

According to the present invention, it is possible to continuously supply the acidic water maintaining the required concentration of chlorine, improve the efficiency of the treatment and decrease the manpower for cleaning the anion-exchange membrane.

What is claimed is:

1. A method for producing electrolyzed water comprising; introducing an aqueous electrolyte solution containing chlorine ions into an electrolytic cell which is separated to two chambers by an anion-exchange membrane and has an electrode in each of the chambers; and applying voltage between each of the electrodes to form acidic water in a chamber having a positive (+) electrode and alkaline ion water in a chamber having a negative (−) electrode,
wherein the polarity of each of the electrodes is switched at time intervals that the aqueous electrolyte solution in each of the chambers is switched between the acidic water and the alkaline ion water.

2. The method for producing electrolyzed water according to claim 1, wherein an acidic water supply port and an alkaline ion water supply port are provided and each of the chambers has a drain outlet for discharging an aqueous electrolyte solution, wherein the drain outlet of each of the chambers is connected to said acidic water supply port when the disposed electrode is a positive (+) electrode and to said alkaline ion water supply port when the disposed electrode is a negative (−) electrode.

3. The method for producing electrolyzed water according to claim 1 or 2, wherein an acidic water tank is connected to said acidic water supply port, and the polarity of each of the electrodes is switched at time intervals that the acidic water in said acidic water tank is maintained at a pH of 2.5±0.2.

4. The method for producing electrolyzed water according to claim 1, 2 or 3, wherein the aqueous electrolyte solution is continuously fed into said electrolytic cell so as to maintain the chlorine concentration of said aqueous electrolyte solution in said electrolytic cell in the range from 30 to 200 ppm.

5. An apparatus for producing electrolyzed water comprises:
an electrolytic cell,
an anion-exchange membrane provided in said electrolytic cell so as to separate said electrolytic cell to two chambers,
electrodes disposed in each of the chambers of said electrolytic cell,
a power source for applying voltage between each of the electrodes, and
an electrode selector for switching the polarity of each of the electrodes at predetermined time intervals.

6. The apparatus for producing electrolyzed water according to claim 5, comprising a water feeding port of an aqueous electrolyte solution into said electrolytic cell, a supply port of acidic water, and a supply port of alkaline ion water,
wherein each of the chambers comprises a drain outlet and a connection selector for connecting the drain outlet of each of the chambers to said acidic water supply port when the disposed electrode is a positive (+) electrode and to said alkaline ion water supply port when the disposed electrode is a negative (−) electrode.

7. The apparatus for producing electrolyzed water according to claim 6, wherein said connection selector comprises an electromagnetic valve, and the polarity of said electromagnetic valve is switched by said electrode selector to connect the drain outlet of each of the chambers to said acidic water supply port when the disposed electrode is a positive (+) electrode and to said alkaline ion water supply port when the disposed electrode is a negative (−) electrode.
